(19) United States
(12) Patent Application Publication
(10) Pub. No.: US 2026/0297785 A1
(43) Pub. Date: Oct. 1, 2026

(54) ELECTROFORMING MASTER PLATE, MANUFACTURING METHOD FOR ELECTROFORMING MASTER PLATE, AND ELECTROFORMED PRODUCT

(71) Applicant: FUJIFILM CORPORATION, Tokyo (JP)

(72) Inventors: Kozue IKEDA, Kanagawa (JP); Tomokazu UMEZAWA, Kanagawa (JP)

(21) Appl. No.: 19/561,556

(22) Filed: Mar. 10, 2026

(30) Foreign Application Priority Data
Mar. 28, 2025 (JP) 2025-057161

(51) Int. Cl. C25D 1/10

(52) U.S. Cl. CPC C25D 1/10

(57) ABSTRACT

Provided are an electroforming master plate including a substrate, a conductive layer provided on a surface of the substrate, an insulating mask pattern provided on the substrate or the conductive layer, and an adhesion control layer provided on a region of the conductive layer in which the insulating mask pattern is not provided, in which the adhesion control layer is a porous film formed of an insulating material and has a thickness of 1 nm to 50 nm, the thickness being thinner than a thickness of the insulating mask pattern, manufacturing method of the same, and an electroformed product.

### CROSS REFERENCE TO RELATED APPLICATIONS

This application claims priority from Japanese Application No. 2025-057161, filed on Mar. 28, 2025, the entire disclosure of which is incorporated herein by reference.

### BACKGROUND

### 1. Technical Field

The present disclosure relates to an electroforming master plate, a manufacturing method for an electroforming master plate, and an electroformed product.

### 2. Related Art

An electroforming method is widely used as a method of manufacturing components, molds, and the like having various shapes. In the electroforming method, an electroforming master plate having a pattern on a surface is used, and an electroformed product is manufactured by electroforming nickel or the like on the master plate.

In order to control a shape of the electroformed product, a pattern formed of an insulating film may be provided on a surface of the electroforming master plate. For example, JP1992-338551A (JP-H4-338551A) and JP2023-044211A disclose a method of manufacturing an electroformed product having a through-hole (hereinafter, simply referred to as a “hole”) at a position corresponding to a mask by growing a metal layer on a conductive surface immersed in an electroforming solution, using an electroforming master plate in which a non-conductive mask is formed on a part of a substrate having a conductive surface. Examples of the electroformed product include a nozzle plate having a plurality of nozzle holes used in a recording head of an inkjet printer.

In order to improve peelability in a case of peeling the electroformed product, the electroforming master plate may include a release layer (also referred to as a parting layer). In JP1992-338551A (JP-H4-338551A), a release coating film is provided on a portion of the electroforming master plate other than the mask. On the other hand, JP2023-044211A proposes that an oxide film of 18 Å or less is provided on a surface in order to improve adhesion of the electroformed product to the electroforming master plate.

### SUMMARY

However, in a case where the release coating film described in JP1992-338551A (JP-H4-338551A) is used, the release coating film may be peeled off in a case of peeling the electroformed product, and the release coating film needs to be formed again after electroforming one electroformed product and peeling the electroformed product. The electroforming master plate described in JP2023-044211A can be used repeatedly a plurality of times, but the durability against the repeated use is not sufficient.

The present disclosure has been made in view of the above circumstances, and an object thereof is to provide an electroforming master plate and a method of manufacturing the electroforming master plate that can be used repeatedly more than in the related art. Another object of the present disclosure is to provide an electroformed product manufactured using the electroforming master plate.

An electroforming master plate according to the present disclosure, comprising:
a substrate;
a conductive layer provided on a surface of the substrate;
an insulating mask pattern provided on the substrate or the conductive layer; and
an adhesion control layer provided on the conductive layer,
in which the adhesion control layer is a porous film formed of an insulating material and has a thickness of 1 nm to 50 nm, the thickness being thinner than a thickness of the insulating mask pattern.

It is preferable that a residual film thickness in a hole portion of the adhesion control layer is 15 nm or less.

It is preferable that the adhesion control layer does not include a metal forming an electroformed product.

It is preferable that a contact area between the conductive layer and an electroforming solution is 20% to 60% of a total area of the conductive layer beneath the adhesion control layer.

The insulating mask pattern may include a dot or a line having a height of 50 nm or more and a width of 50 nm or more.

It is preferable that the substrate is silicon, and the conductive layer is an alloy of silicon and a metal.

It is preferable that the adhesion control layer is a silicon oxide.

A manufacturing method for an electroforming master plate according to the present disclosure includes:
a step of removing a natural oxide film on a silicon substrate having an insulating mask pattern on a surface of the silicon substrate;
a step of forming a metal film on the silicon substrate;
a step of forming a capping layer on the metal film;
a step of annealing a structure including the metal film and the capping layer on the silicon substrate; and
a washing step of removing the capping layer.

In the step of removing the natural oxide film, it is preferable that the natural oxide film is removed by reverse sputtering using argon under vacuum.

It is preferable that after the step of removing the natural oxide film, the step of forming a metal film and the step of forming the capping layer are performed without returning to an atmospheric environment.

It is preferable that the annealing is performed at a temperature of 200° C. to 400° C.

In the washing step, it is preferable that the capping layer is removed using an acid washing solution.

An electroformed product according to the present disclosure manufactured using the electroforming master plate according to the present disclosure, in which the electroformed product has, on one surface, a structural portion corresponding to the insulating mask pattern and unevenness having a depth of 1 nm to 50 nm and a surface roughness of 1 nm to 10 nm, the unevenness corresponding to unevenness of the surface of the porous film.

According to the present disclosure, it is possible to provide an electroforming master plate and a manufacturing method for an electroforming master plate that can be used repeatedly more than in the related art. According to the present disclosure, an electroformed product manufactured using such an electroforming master plate can be provided.

### BRIEF DESCRIPTION OF THE DRAWINGS

FIG. 1 is a perspective view showing an example of a metal molded article.

FIG. 2 is a plan view showing an electroforming master plate.

FIG. 3 is a cross-sectional view of a part of the electroforming master plate.

FIG. 4 is an enlarged view of a part of an adhesion control layer of the electroforming master plate.

FIG. 5 is a cross-sectional view of a part of an electroforming master plate of a modification example.

FIG. 6 is a diagram showing a manufacturing step of the electroforming master plate (part 1).

FIG. 7 is a diagram showing a manufacturing step of the electroforming master plate (part 2).

FIG. 8 is a diagram showing a manufacturing step of the electroformed product.

FIG. 9 is an AFM image showing an uneven structure of a surface of the electroformed product on an electroforming master plate side.

FIG. 10 is an SEM image showing a shape change of the adhesion control layer by acid washing.

FIG. 11A is an AFM image of a surface of an adhesion control layer of an electroforming master plate of Example 5, and FIG. 11B is a diagram showing a cross-sectional structure at a linear position in FIG. 11A.

FIGS. 12A to 12C are explanatory diagrams of a method of calculating a depth of a hole portion.

FIG. 13A is an AFM image of a surface of an adhesion control layer of an electroforming master plate of Example 1, and FIG. 13B is a diagram showing a cross-sectional structure at a linear position in FIG. 13A.

FIG. 14 is a TEM image of a cross section of the electroforming master plate of Example 5.

FIG. 15 is a diagram showing a result of compositional analysis using XPS in a depth direction from a surface of the electroforming master plate of Example 5.

FIG. 16 is an AFM image of an adhesion control layer of Examples 1 to 5 and an image for volume measurement using imageJ.

FIG. 17 is a diagram showing a measurement result of an annealing temperature dependence of a surface roughness of a surface of the electroformed product on an electroforming master plate side.

FIG. 18 is a diagram showing a measurement result of an annealing temperature dependence of a surface roughness of a surface of the electroformed product on a growth surface side.

### DESCRIPTION OF EMBODIMENTS

Hereinafter, embodiments of the present disclosure will be described with reference to the drawings. In each of the drawings, the same reference numerals are given to the same components. For easy visual recognition, a film thickness and a ratio of each layer are appropriately changed and drawn, and do not necessarily reflect the actual film thickness and ratio. The same applies to the following drawings.

### Electroformed Product

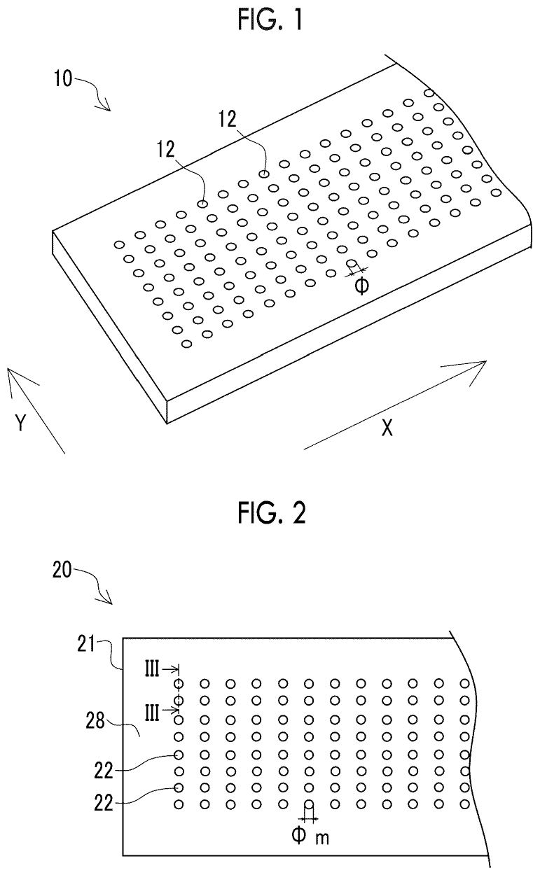

FIG. 1 shows a nozzle plate 10 which is an example of an electroformed product manufactured by electroforming using an electroforming master plate 20 according to one embodiment. The nozzle plate 10 is a plate having a plurality of nozzle holes 12 for discharging ink, which is used in a recording head of an inkjet printer.

The nozzle plate 10 is a plate-shaped member having a rectangular planar shape which is formed of an electroforming metal such as nickel (Ni). A plurality of substantially circular holes functioning as the nozzle holes 12 are two-dimensionally arranged and formed in the nozzle plate 10. The nozzle hole 12 is formed in a substantially circular shape, and a diameter q thereof is, for example, 100 μm or less, and preferably 20 μm to 50 μm. In the recording head, the nozzle plate 10 is disposed in a posture in which a longitudinal direction corresponds to a main scanning direction X of the inkjet printer and a lateral direction corresponds to a sub-scanning direction Y. A length of the nozzle plate 10 in the main scanning direction is, for example, 100 mm, and a length of the nozzle plate 10 in the sub-scanning direction is, for example, 40 mm. Further, in the present example, eight nozzle rows including 130 nozzle holes 12 arranged at regular intervals in the main scanning direction X of the nozzle plate 10 are provided in the sub-scanning direction Y.

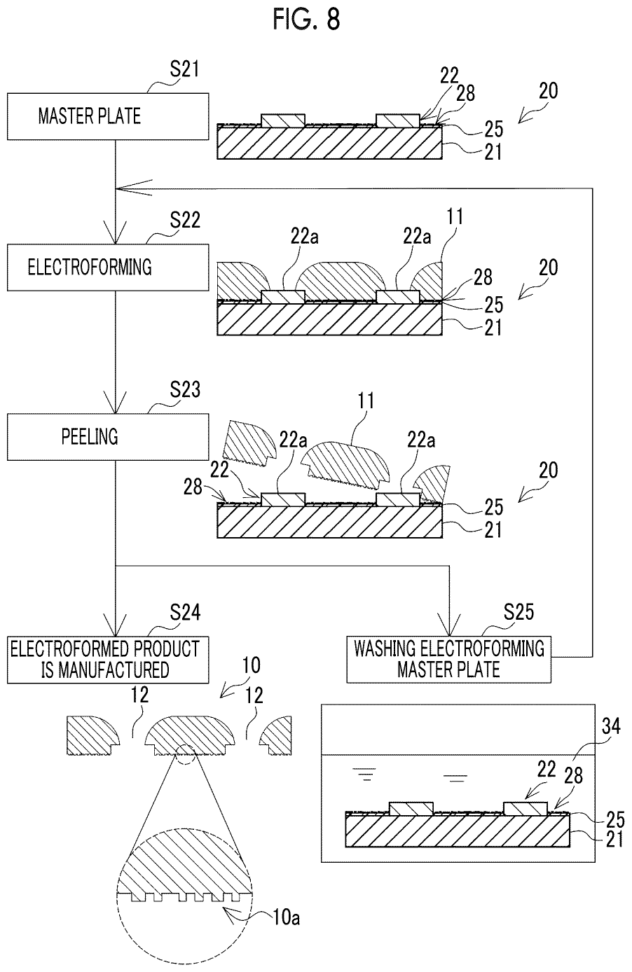

The nozzle plate 10 is manufactured by electroforming using an electroforming master plate 20 described below, and has unevenness 10a (see FIG. 8) having a depth of 1 nm to 50 nm and a surface roughness Ra of 1 nm to 10 nm on a surface peeled off from the electroforming master plate 20, corresponding to unevenness of a surface of a porous film of the electroforming master plate 20 described below.

By providing the nozzle plate 10 with the fine unevenness 10a on a nozzle surface having a nozzle opening 12, a liquid-repellent effect on the ink during discharging of the ink is expected.

### Electroforming Master Plate

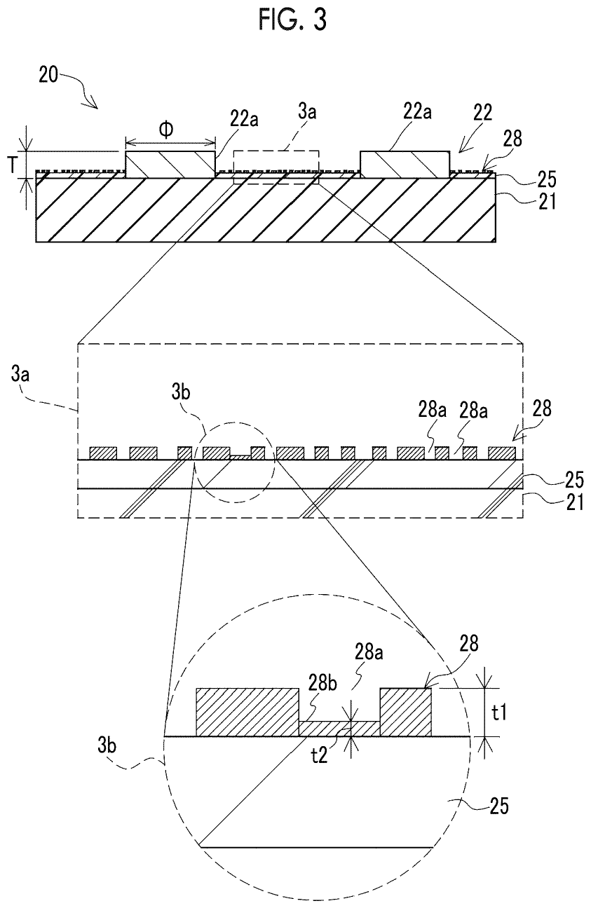

FIG. 2 is a plan view showing a part of the electroforming master plate 20 according to the embodiment used for manufacturing the nozzle plate 10, and FIG. 3 is a cut end surface view of a portion of the electroforming master plate 20 shown in FIG. 2 taken along a line III-III.

The electroforming master plate 20 includes a substrate 21, a conductive layer 25, an insulating mask pattern 22, and an adhesion control layer 28.

### Substrate

As the substrate 21, a semiconductor substrate is preferable, and specific examples thereof include a silicon (Si) substrate and a germanium (Ge) substrate. As the substrate 21, a silicon substrate is particularly preferable. In a case of being a semiconductor substrate, the substrate may be n-type or p-type, and may be an intrinsic semiconductor not containing an impurity.

### Conductive Layer

The conductive layer 25 is provided on a surface of the substrate 21. The conductive layer 25 has conductivity and functions as an electrode during electroforming. The conductive layer 25 is an alloy layer including a constituent element of the substrate 21 and a metal element. The conductive layer 25 may be, for example, a layer in which a metal element is diffused into a surface layer of the substrate 21 which is a semiconductor substrate.

For example, in a case where the substrate 21 is a silicon substrate, the conductive layer 25 is an alloy layer including silicon, which is a constituent element, and a metal element. Examples of the metal element include nickel (Ni), tantalum (Ta), chromium (Cr), cobalt (Co), molybdenum (Mo), palladium (Pd), tungsten (W), platinum (Pt), titanium (Ti), vanadium (V), niobium (Nb), hafnium (Hf), zirconium (Zr), and an alloy thereof. Nickel or chromium used as an electroforming metal is particularly preferable. In a case where the substrate 21 is a silicon substrate and the metal for alloying is nickel, the conductive layer 25 is nickel silicide.

### Insulating Mask Pattern

The insulating mask pattern 22 is provided in order to form an opening (here, the nozzle hole 12 of the nozzle plate 10) of a metal molded article. In the present example, a dot-shaped mask 22a corresponding to the nozzle hole 12 is provided. The mask 22a is formed at a portion corresponding to a nozzle forming position in order to form the nozzle hole 12 provided in the nozzle plate 10. In the present example, the mask 22a is dot-shaped. Since the mask 22a is insulating, a metal does not grow in a portion of the mask 22a, and an opening is formed, so that the nozzle hole 12 is formed. In the present example, 130×8 masks 22a are formed in a region of 100 mm×40 mm of the electroforming master plate 20 corresponding to the arrangement pitch and the number of the nozzle holes 12 of the nozzle plate 10 described above. A diameter φm of the mask 22a is larger than the diameter φ of the nozzle hole 12, and is, for example, 150 μm to 200 μm. In addition, a thickness T of the mask 22a is, for example, 2 μm.

In the present embodiment, the electroforming master plate for a nozzle plate is described as an example, but the electroformed product to which the electroforming master plate according to the present disclosure can be applied is not limited to the nozzle plate. The insulating mask pattern may be provided according to a shape of a desired electroformed product, and the shape of the mask is not limited to the dot and may have any shape such as a line or a rectangle. In addition, a thickness and a size of each mask are also set according to the desired electroformed product. However, the thickness of the mask is 50 nm or more, and a width (here, a minimum value of a width of facing sides) is preferably 50 nm or more.

The insulating mask pattern 22 is composed of, for example, an insulating layer formed by an insulating treatment on a surface of the substrate 21 consisting of a semiconductor. The insulating treatment on the surface of the substrate 21 is a treatment of diffusing an element such as oxygen, nitrogen, or oxygen and nitrogen, which is bonded to a substrate constituting element to form an insulator, into the surface of the substrate 21, and specific examples thereof include a thermal diffusion treatment and an ion implantation treatment using ion beam mixing. In a case of the thermal diffusion treatment, for example, the substrate 21 is subjected to a heat treatment in a gas containing oxygen, a gas containing nitrogen, or a gas containing oxygen and nitrogen, and oxygen, nitrogen, or a combination of oxygen and nitrogen is thermally diffused into the surface layer of the substrate 21. In a case of the ion implantation treatment, for example, oxygen ions, nitrogen ions, or oxygen ions and nitrogen ions are implanted into the surface of the substrate 21 as an ion beam, and are diffused into the surface layer of the substrate 21. By such a treatment, in the surface layer of the substrate 21, the constituent element constituting the substrate 21 is oxidized, nitrided, or oxynitrided, so that an oxide, a nitride, or an oxynitride of the constituent element is formed and becomes insulating. That is, the insulating layer formed by the insulating treatment on the surface of the substrate 21 is an insulating region in the surface layer of the substrate 21 by the insulating treatment. The insulating layer formed by the insulating treatment is preferably the oxide, the nitride, or the oxynitride of the constituent element of the substrate 21. As the insulating layer formed by the insulating treatment, a thermal oxide film which is an oxide of the constituent element of the substrate 21 formed by the thermal diffusion treatment, a thermal nitride film which is a nitride of the constituent element of the substrate 21, or a thermal oxynitride film which is an oxynitride of the constituent element of the substrate 21 is preferable.

The insulating mask pattern 22 is obtained by patterning the insulating layer (that is, the insulating region of the surface layer of the substrate 21) formed on the surface of the substrate 21 by the atomic diffusion as described above.

### Adhesion Control Layer

The adhesion control layer 28 is provided on the conductive layer 25. A drawing (hereinafter, referred to as a first enlarged view 3a) showing an enlarged view of a part 3a of the adhesion control layer 28, and a drawing (hereinafter, referred to as a second enlarged view 3b) showing an enlarged view of a part 3b of the adhesion control layer 28 are shown in FIG. 3.

The adhesion control layer 28 is a layer for controlling an adhesion force of the electroformed product (here, the nozzle plate 10) to the electroforming master plate 20. The adhesion control layer 28 is provided in order to prevent the occurrence of floating in an electroforming metal layer deposited on the surface of the electroforming master plate 20 during electroforming and to improve peelability in a case of peeling the electroformed product off from the electroforming master plate 20 after electroforming.

As shown in FIG. 3, the adhesion control layer 28 is a porous film formed of an insulating material and having a plurality of hole portions 28a. A thickness t1 (see the second enlarged view 3b in FIG. 3) of the adhesion control layer 28 is 1 nm to 50 nm and is thinner than the thickness T of the insulating mask pattern 22. The thickness t1 of the adhesion control layer 28 is preferably about 20% or less of the thickness T of the insulating mask pattern 22. The adhesion control layer 28 is not provided on each mask 22a of the insulating mask pattern 22. The thickness t1 of the adhesion control layer 28 can be determined by a transmission electron microscope (TEM) observation or an atomic force microscope (AFM) measurement of a cross section.

As shown in the first enlarged view 3a, the hole portion 28a of the adhesion control layer 28 may penetrate through the conductive layer 25 or may not penetrate through the conductive layer 25. However, a thickness t2 (see the second enlarged view 3b) of a residual film 28b in the hole portion 28a is preferably 15 nm or less.

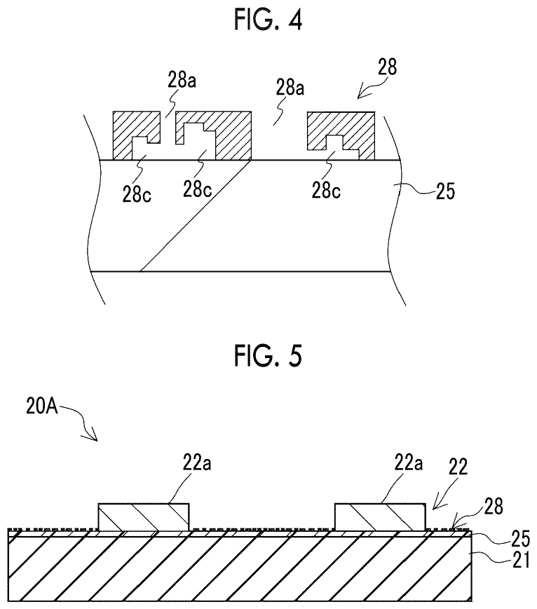

FIG. 4 is an enlarged view showing another part of the adhesion control layer 28. As shown in FIG. 4, the adhesion control layer 28 may include a cavity portion 28c that does not adhere to the conductive layer 25 in a part.

In a case of electroforming, it is preferable that a contact area between the conductive layer 25 and the electroforming solution is 20% to 60% of a total area of the conductive layer 25 disposed beneath the adhesion control layer 28. It is preferably 20% to 50% and more preferably 25% to 45%. The “contact area between the conductive layer 25 and an electroforming solution is 20% to 60% of a total area of the conductive layer underlying the adhesion control layer 28” means that a surface of the conductive layer 25 disposed beneath the adhesion control layer 28 that does not contact the adhesion control layer 28 is 20% to 60%. The portion of the adhesion control layer 28 that does not contact the conductive layer 25 is a portion exposed to the hole portion 28a of the adhesion control layer 28 or a portion facing the cavity portion 28c.

It is preferable that the adhesion control layer 28 does not include a metal (the above-described electroforming metal) at least forming the electroformed product. It is preferable that the adhesion control layer 28 includes an element constituting the substrate 21. In a case where the substrate 21 is a silicon substrate, the adhesion control layer 28 is preferably a silicon oxide. The adhesion control layer 28 may be, for example, germanium oxide (GeO) or silicon oxycarbide (SiCO).

### Electroforming Master Plate of Modification Example

FIG. 5 shows a cross section of a portion of an electroforming master plate 20A of a modification example corresponding to FIG. 3.

In the electroforming master plate 20A of the modification example shown in FIG. 5, the conductive layer 25 is also provided between each mask 22a constituting the insulating mask pattern 22 and the substrate 21. The adhesion control layer 28 is not provided between the mask 22a and the conductive layer 25. That is, the adhesion control layer 28 is formed only on a portion of the surface of the conductive layer 25 where the mask 22a is not formed.

In a case of the electroforming master plate 20A of the modification example, the insulating mask pattern 22 can be composed of an insulating layer formed after the conductive layer 25 is formed on the surface of the substrate 21, unlike the insulating layer provided in advance on the surface of the substrate 21.

The electroforming master plate 20 according to the present embodiment and the electroforming master plate 20A of the modification example include the substrate 21, the conductive layer 25 provided on the surface of the substrate 21, the insulating mask pattern 22 provided on the substrate 21 or the conductive layer 25, and the adhesion control layer 28 provided on the conductive layer 25. The adhesion control layer 28 is a porous film formed of an insulating material, has a thickness of 1 nm to 50 nm, and is thinner than the thickness of the insulating mask pattern 22. With such a configuration, the adhesion control layer 28 which is a porous film and has a thickness t1 of 1 nm to 50 nm is provided on the surface of the conductive layer 25, so that the adhesiveness of the electroformed product to the electroforming master plate 20 can be reduced while ensuring the surface conductivity. Since the adhesiveness can be reduced, the electroformed product can be easily peeled off. In a case where the thickness t1 of the adhesion control layer 28 is less than 1 nm, the decrease in the conductivity is small, so that the adhesiveness between the electroformed product and the electroforming master plate 20 is high and the peeling is difficult. In addition, in a case where the thickness t1 of the adhesion control layer 28 is more than 50 nm, air is accumulated in the hole portion 28a, and the electroforming solution does not sufficiently permeate into the hole portion 28a, so that the electroforming defect may occur.

In a case where the thickness of the residual film 28b in the hole portion 28a of the adhesion control layer 28 is 15 nm or less, the decrease in the conductivity of the conductive layer 25 can be suppressed, and the favorable deposition of the electroforming metal can be performed.

In a case where the adhesion control layer 28 does not include a metal (electroforming metal) forming the electroformed product, the adhesion force between the electroformed product and the electroforming master plates 20, 20A is suppressed, and the electroformed product is easily peeled off from the electroforming master plates 20, 20A.

In a case where the contact area between the conductive layer 25 and the electroforming solution is 20% to 60% of the total area of the conductive layer 25 beneath the adhesion control layer 28, the peeling due to the occurrence of the floating of the electroformed product during the deposition in the electroforming can be suppressed, and the peelability in a case of peeling the electroformed product after the electroforming can be improved.

### Method of Manufacturing Electroforming Master Plate

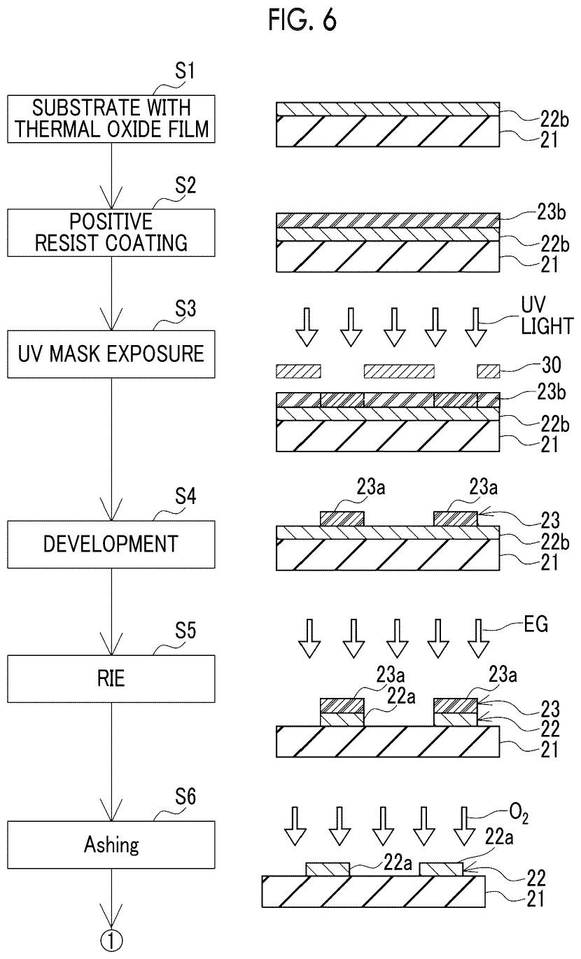

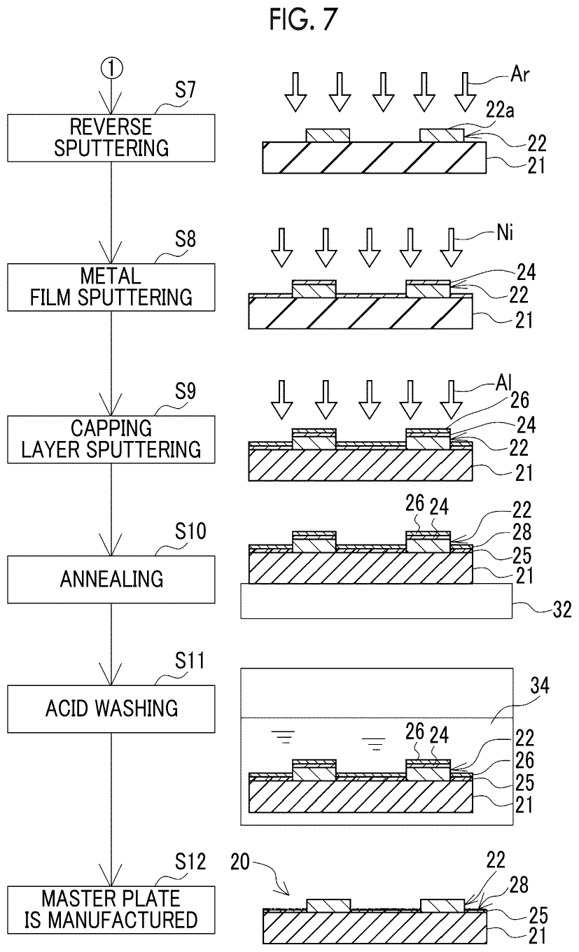

As the embodiment of the method of manufacturing the electroforming master plate according to the present disclosure, the method of manufacturing the electroforming master plate 20 will be described with reference to FIGS. 6 and 7. FIGS. 6 and 7 are diagrams showing a series of manufacturing steps.

First, a substrate 21 with a thermal oxide film 22b is prepared (step S1). For example, a silicon wafer is used as the substrate 21, and a thermal oxide film 22b as an insulating layer is formed on the surface of the substrate 21 by performing a heat treatment in a gas containing oxygen to diffuse oxygen into a surface layer, thereby obtaining a substrate with a thermal oxide film. A commercially available thermal oxide film silicon wafer may be prepared. A thickness of the thermal oxide film 22b is, for example, 2 μm. Hereinafter, the substrate 21 is a silicon substrate 21.

Next, a positive resist film 23b is formed on the thermal oxide film 22b by applying a positive resist (step S2). Then, UV mask exposure using UV (Ultra Violet) light using a mask 30 for pattern formation is performed (step S3). Thereafter, a resist pattern 23 is formed by performing a development treatment (step S4). Steps S2 to S4 are steps of forming the resist pattern 23 on the thermal oxide film 22b. The resist pattern 23 is a pattern including a plurality of resist masks 23a.

Further, the thermal oxide film 22b is etched using the resist pattern 23 as a mask to form the insulating mask pattern 22 including a plurality of insulating masks 22a (step S5). Here, reactive ion etching (RIE) is performed. In step S5, the arrow schematically indicates an etching gas EG during dry etching.

Next, an ashing treatment (step S6) using oxygen plasma is performed in order to remove the resist pattern 23 remaining on the insulating mask pattern 22.

Subsequently, a reverse sputtering treatment (step S7) is performed on the surface of the silicon substrate 21. In the silicon substrate 21, the surface may be oxidized in the air to form a natural oxide film. Here, the natural oxide film is removed by performing the reverse sputtering treatment on the surface of the substrate 21 before forming the metal film 24 on the surface of the silicon substrate 21. Here, in a sputter film forming device, sputtering using argon is performed under vacuum. In step S7, the direction of the arrow indicates a traveling direction of the sputter ion Ar during the reverse sputtering. The present reverse sputtering treatment is an example of a step of removing the natural oxide film. The method of removing the natural oxide film is not limited to the reverse sputtering treatment, and a method of cleaning the surface of the silicon substrate 21 by irradiating the surface with an ion beam may be used.

Thereafter, a metal film 24 is formed on the surface of the silicon substrate 21 by a sputtering method (step S8), and a capping layer 26 is further formed on the metal film 24 by the sputtering method (step S9). For example, the metal film 24 is a nickel layer, and the capping layer 26 is an aluminum layer. The metal film 24 is formed on a surface of the silicon substrate 21 where the insulating mask pattern 22 is not formed and on the insulating mask pattern 22. The capping layer 26 is formed on the metal film 24 on the silicon substrate 21 and on the metal film 24 on the insulating mask pattern 22.

Here, the capping layer 26 is a layer provided on the surface of the metal film 24 in order to prevent the surface of the metal film 24 from being oxidized during the sputtering of the metal film 24 and the subsequent annealing treatment. The capping layer 26 is an aluminum layer in the present example, but may be a layer consisting of titanium (Ti), tungsten (W), molybdenum (Mo), vanadium (V), or the like. It is preferable that the capping layer 26 consists of a material that has less diffusion in the subsequent annealing treatment step and is easily dissolved in a washing solution in the washing step.

A film thickness of the metal film 24 is preferably 5 nm or more and 200 nm or less, and more preferably 10 nm or more and 100 nm or less.

A film thickness of the capping layer 26 is preferably 5 nm or more and 200 nm or less, and more preferably 10 nm or more and 100 nm or less.

A series of steps from the reverse sputtering treatment (step S7) for removing the natural oxide film to the film formation of the metal film 24 (step S8) and the film formation of the capping layer 26 (step S9) are continuously executed in the sputter film forming device. As described above, it is preferable that a step of forming a metal film 24 and a step of forming a capping layer 26 are performed after the step of removing the natural oxide film without returning to an atmospheric environment.

Thereafter, an annealing treatment is performed (step S10). The annealing treatment is performed on, for example, a hot plate 32. Here, the structure including the metal film 24 and the capping layer 26 on the silicon substrate 21 is annealed to mutually diffuse the metal element (here, Ni) constituting the metal film 24 and the constituent element (here, Si) of the silicon substrate 21. Nickel is diffused from the surface of the substrate 21 into the substrate 21, and a part of silicon of the silicon substrate 21 is diffused into the metal film 24. As a result, the conductive layer 25 consisting of nickel silicide is formed on the surface of the silicon substrate 21. The conductive layer 25 is formed at a portion where the silicon substrate 21 and the metal film 24 are in contact with each other. On the other hand, the metal element of the metal film 24 on the mask 22a is not diffused into the mask 22a, and the metal film 24 on the mask 22a is maintained even after heating. In this case, a metal element (here, Al) constituting the capping layer 26 may be partially diffused into the metal film 24, but the amount of movement is small and the diffusion is hardly observed as compared with the movement of Ni and Si.

Here, the hot plate 32 is used as a heating device, but a rapid thermal annealing (RTA) device or the like may be used as the heating device. The heating atmosphere is not particularly limited, and may be in the air, in a vacuum, or in an inert gas atmosphere such as nitrogen or argon. The conditions such as the heating temperature and time may be appropriately selected depending on the metal element to be used. For example, in the present example in which the metal film 24 is nickel and the substrate 21 is a silicon wafer, the temperature of the annealing treatment is preferably 200° C. or higher and lower than 500° C., more preferably 300° C. or higher and 400° C. or lower, and still more preferably 350° C. or higher and 400° C. or lower. A treatment time of the annealing treatment is preferably 1 minute or longer and 60 minutes or shorter, and more preferably 5 minutes or longer and 20 minutes or shorter.

Finally, acid washing is performed (step S11). This step is a washing step of removing the capping layer 26 and the metal film 24 remaining on the surface of the substrate 21. Specifically, washing is performed using an acid washing solution 34 such as sulfamic acid or a mixed solution of sulfuric acid and hydrogen peroxide. Here, the capping layer 26 and the metal film 24 on the mask 22a, and the capping layer 26 and the unalloyed portion of the metal film 24 in a portion other than the mask 22a are removed. In this step, the adhesion control layer 28 consisting of a porous film is formed on the surface of the conductive layer 25. The adhesion control layer 28 is composed of a constituent element of the substrate 21 and oxygen. Here, the adhesion control layer 28 is a silicon oxide. The adhesion control layer 28 is formed by bonding silicon diffused into the metal film 24 and oxygen in a washing solution.

As described above, the electroforming master plate 20 can be obtained (step S12).

The method of manufacturing the electroforming master plate according to the present embodiment includes a step (step S7) of removing a natural oxide film on the silicon substrate 21 having an insulating mask pattern on a surface, a step (step S8) of forming a metal film 24 on the silicon substrate 21, a step (step S9) of forming a capping layer 26 on the metal film 24, a step (step S10) of annealing a structure including the metal film 24 and the capping layer 26 on the silicon substrate 21, and a washing step (step S11) of removing the capping layer 26. In a case where the natural oxide film is formed on the surface of the silicon substrate 21, the natural oxide film acts as a barrier during the subsequent annealing treatment, and the mutual diffusion of the metal element and the silicon is prevented, which suppresses the formation of the conductive layer 25 consisting of an alloy, but by including the step S7 of removing the natural oxide film as in the present embodiment, the silicidation of the metal layer by thermal diffusion can be promoted.

In a case where the step S7 of removing the natural oxide film is performed by reverse sputtering using argon under vacuum, the metal film or the like can be formed by sputtering without returning to the atmospheric environment. Then, by forming the metal film without returning to the atmospheric environment after the removal of the natural oxide film, the reformation of the natural oxide film can be suppressed.

By performing the annealing at a temperature of 200° C. to 400° C., the conductive layer 25 that is firmly adhered to the substrate 21 can be obtained (see Examples below).

In the washing step, in a case where the acid washing solution is used, the capping layer and the metal layer can be sufficiently removed. In addition, in a case of using the silicon substrate 21 as in the present embodiment, the adhesion control layer 28 consisting of a silicon oxide can be formed by using the acid washing solution.

### Manufacturing Method for Electroformed Product

Next, a manufacturing step of the nozzle plate 10 as the electroformed product will be described with reference to FIG. 8.

The electroforming master plate 20 is prepared (step S21). The preparation step S21 of the electroforming master plate 20 is realized by the above-described method of manufacturing the electroforming master plate 20.

Electroforming is performed in a state where the electroforming master plate 20 is immersed in an electroforming solution in an electroforming tank (not shown) (step S22). In the electroforming step S22, the conductive layer 25 is energized in the electroforming solution, and a metal layer is grown on the surface of the electroforming master plate 20 by a metal precipitated from the electroforming solution.

In the electroforming step S22, the metal layer 11 grows on the surface of the adhesion control layer 28, but the metal is not precipitated on the surface of the insulating mask pattern 22, and the metal layer 11 does not grow. The metal layer 11 gradually grows on the surface of the adhesion control layer 28. Thereafter, in a case where the thickness of the grown metal layer 11 exceeds the thickness of the mask 22a, the metal layer 11 grows from the surface of the metal layer 11 grown earlier to the mask 22a side so as to overlap the edge portion of the mask 22a. As the metal layer 11 grows from the edge portion of the mask 22a toward the center, an opening is formed in the metal layer 11 with the opening center at a substantially center position of the mask 22a. The opening is the nozzle hole 12. As the thickness of the metal layer 11 increases, the metal layer 11 grows toward the center of the mask 22a. Therefore, the opening diameter of the nozzle hole 12 also gradually decreases. The diameter of the mask 22a is determined such that the nozzle hole 12 has a desired opening diameter in a case where the metal layer 11 is grown to have a desired thickness. On the mask 22a, the growth of the metal layer 11 proceeds closer to the surface of the conductive layer 25. Therefore, as shown in the step S22 of FIG. 8, the opening diameter of the nozzle hole 12 is smaller as it is closer to the surface of the conductive layer 25 and is larger as it is farther from the surface of the conductive layer 25, and a cross section of the metal layer 11 constituting the inner wall surface of the nozzle hole 12 is arc-shaped. For example, the opening diameter of the nozzle hole 12 closer to the surface of the conductive layer 25 is set as a reference of the target opening diameter of the nozzle hole 12. The diameter of the mask 22a is determined such that the opening diameter of the nozzle hole 12 as the reference is the target opening diameter. The thickness of the metal layer 11 is, for example, about 50 μm.

Next, the metal layer 11 (electroformed product) deposited by the electroforming is peeled off from the electroforming master plate 20 (step S23). In this case, the mask 22a remains on the silicon substrate 21 without being peeled off from the silicon substrate 21. As described above, the nozzle plate 10, which is the electroformed product, can be obtained by electroforming using the electroforming master plate 20 (step S24).

As shown in the step S24 of FIG. 8, the nozzle plate 10 has the nozzle hole 12 as a structural portion corresponding to the insulating mask pattern and the unevenness 10a having a depth of 1 nm to 50 nm and a roughness of 1 nm to 10 nm corresponding to unevenness of the surface of the porous film constituting the adhesion control layer 28 on the peeling surface for electroforming.

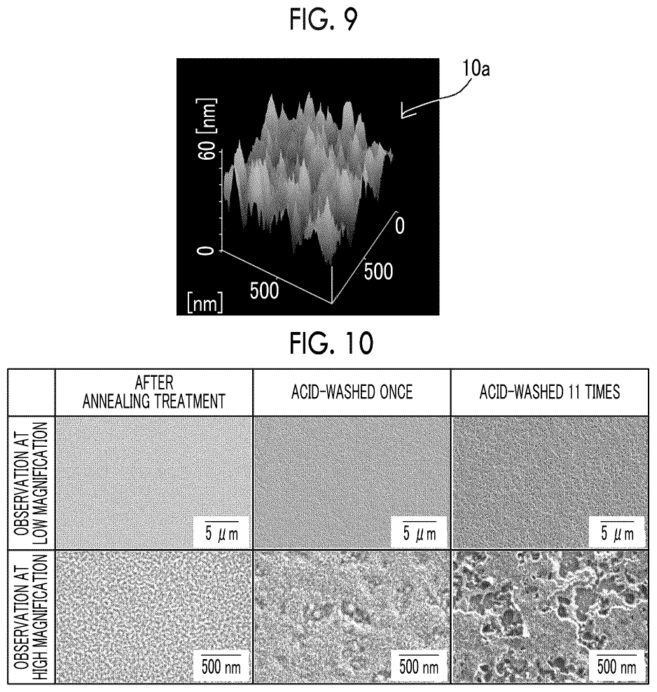

In the electroformed product manufactured using a prototype of the electroforming master plate actually produced, the fine unevenness 10a as shown in FIG. 9 was observed. FIG. 9 is a surface AFM image of the electroformed product.

On the other hand, after the peeling step S23, the electroforming master plate 20 from which the nozzle plate 10 is peeled off is washed using the acid washing solution 34 (step S25). As the acid washing solution 34, a mixed solution of sulfuric acid and hydrogen peroxide or sulfamic acid can be used. In the electroforming master plate 20 after the peeling step, an electroforming metal or the like is attached to a part thereof. In the washing step S25, the electroforming metal or the like remaining on the surface after the peeling is removed, and the electroforming master plate 20 returns to the state before the electroforming.

By repeating the electroforming step S22, the peeling step S23, and the washing step S25, a plurality of nozzle plates 10, which are the electroformed products, can be manufactured using one electroforming master plate 20.

The electroforming master plate 20 according to the present embodiment includes the insulating mask pattern 22 provided by insulating (here, thermally oxidizing) a part of the silicon substrate 21 and patterning the insulating part, and further includes the conductive layer 25 including the constituent element of the silicon substrate 21 and the metal element of the metal film 24. According to this configuration, the insulating mask pattern 22 and the conductive layer 25 are not peeled off in a case of peeling the nozzle plate 10, which is the electroformed product. In the washing step S25, only the electroforming residue and the attachment remaining on the surface of the electroforming master plate 20 after the peeling can be removed without the electroforming master plate 20 being eroded by the acid washing solution 34 such as the sulfuric acid hydrogen peroxide mixed solution. Thereafter, the nozzle plate 10 can be repeatedly manufactured by repeatedly using the electroforming master plate 20 without re-forming the mask pattern 22, performing the treatment of imparting conductivity, and the like.

However, the shape of the adhesion control layer 28 of the electroforming master plate 20 gradually changes by repeatedly using the electroforming master plate 20, that is, by performing the washing step S25 a plurality of times.

FIG. 10 shows a result of observing the shape change of the adhesion control layer 28 by the acid washing. In FIG. 10, “after annealing treatment” means a state before the acid washing after the annealing step S10 of FIG. 7 in the manufacturing step of the electroforming master plate 20. Here, the annealing treatment was performed at 400° C. for 10 minutes. “After one acid washing” means before the use after the washing step S11 of FIG. 8 in the manufacturing step of the electroforming master plate 20. The acid washing once in the present example is a treatment of immersing in a mixed solution of sulfuric acid and hydrogen peroxide for 60 minutes. The acid washing 11 times means after repeating the washing step S11 11 times. Each of the images is a scanning electron microscope (SEM) image of the surface of the adhesion control layer 28, and shows a case of being observed at a low magnification and a case of being observed at a high magnification.

The image after the annealing treatment is a surface of the capping layer 26. The capping layer 26 has fine unevenness in which unevenness is hardly observed at the low-magnification image. The image of the acid washing once is a surface of the adhesion control layer 28. It is observed that unevenness is generated on the surface from the low-magnification image. It is observed that fine unevenness and large recessed portions are formed from the high-magnification image. In addition, the image of the acid washing 11 times is a surface of the adhesion control layer 28, and it is observed that recessed portions are expanded and a large number of large recessed portions are formed as compared with the case of the acid washing once. It is considered that the adhesion control layer 28 including the cavity portion 28c as shown in FIG. 4 is formed by repeating the acid washing a plurality of times.

In any of the adhesion control layers of the acid washing once and the acid washing 11 times, it was possible to achieve both the favorable adhesiveness during the electroforming and the easy peelability during the peeling. In addition, it was possible to produce an electroformed product that could be used sufficiently 20 or more times using one electroforming master plate 20.

### Verification of Adhesion Force of Adhesion Control Layer Depending on Annealing Temperature and Difference in Adhesion Control Layer

A result of producing a sample of the electroforming master plate not including the insulating mask pattern and verifying the difference in the adhesion control layer depending on the annealing temperature and the adhesion force depending on the difference in the adhesion control layer will be described.

Hereinafter, a sample satisfying the conditions of the electroforming master plate according to the present disclosure, except that the insulating mask pattern is not provided, is an example, and the other is a comparative example.

In the manufacturing step of the electroforming master plate described in the above-described embodiment, the treatments of the steps S7 to S11 were performed on the silicon substrate with the thermal oxide film to produce the electroforming master plates of Examples 1 to 5 and Comparative Examples 1 and 2. The conditions of Examples 1 to 5 and Comparative Example 2 were the same except for the annealing temperature. The electroforming plate of Comparative Example 1 was produced under the same conditions as in Example 1, and the thickness of the adhesion control layer was reduced to 1 nm or less by the ashing treatment at the end. Each of the annealing temperatures was as shown in Table 1.

In addition, the electroforming was performed using each of the electroforming master plates. Here, nickel was electroformed to deposit a nickel layer having a thickness of 1 μm, and the electroformed product was peeled off from the electroforming master plate to obtain the electroformed product.

The thickness of the adhesion control layer and the depth of the hole portion 28a were obtained for Examples 1 to 5. In addition, the electroformed product was produced using each of Examples 1 to 5, and the adhesion force of the electroformed product, the evaluation of the electroformed product, and the roughness of the surface unevenness of the electroformed product were measured. The results are shown in Table 1.

TABLE 1

| | Comparative | Example | Example | Example | Example | Example | Comparative |
|---|---|---|---|---|---|---|---|
| | Example 1 | 1 | 2 | 3 | 4 | 5 | Example 2 |
| Annealing | 200° C. | 200° C. | 250° C. | 300° C. | 350° C. | 400° C. | 500° C. |
| temperature | | | | | | | |
| Thickness of | Less than 1 | 4 | 4 | 4 | 13 | 25 | More than 50 |
| adhesion control | | | | | | | |
| layer (nm) | | | | | | | |
| Depth of hole | Less than 1 | 1.9 | 1.3 | 1.4 | 7.6 | 7.8 | More than 50 |
| portion (nm) | | | | | | | |
| Contact area [%] | 75 | 54 | 47 | 41 | 41 | 27 | 10 |
| Adhesiveness | Electroforming | Strong ↔ Weak | | | | | Electroforming |
| between master | unavailable | | | | | | unavailable |
| plate and | | | | | | | |
| electroformed | | | | | | | |
| product | | | | | | | |
| Electroforming | C | B | B | B | A | A | C |
| evaluation | | | | | | | |
| Roughness of | — | 0.7 | 3.8 | 5 | 3.8 | 6.4 | — |
| electroformed | | | | | | | |
| product on master | | | | | | | |
| plate surface side | | | | | | | |
| (nm) | | | | | | | |

### Measurement of Depth of Hole Portion

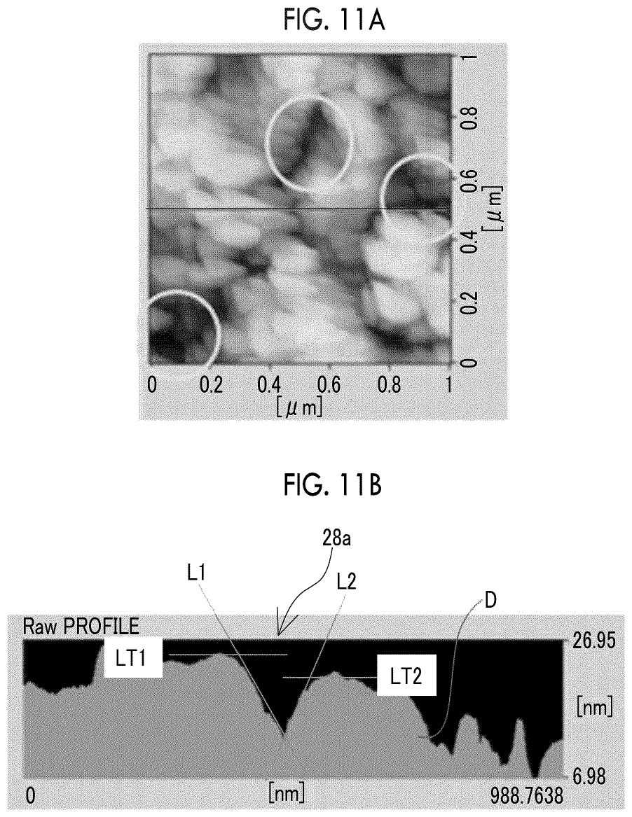

The depth of the hole portion was obtained by AFM evaluation of the surface of the adhesion control layer. FIG. 11A is an AFM image of the adhesion control layer 28 of the electroforming master plate of Example 5. In addition, FIG. 11B is a cross-sectional image of a black line portion shown in the AFM image of FIG. 11A. The units of the vertical axis and the horizontal axis of FIG. 11A are [μm], and the units of the vertical axis and the horizontal axis of FIG. 11B are [nm].

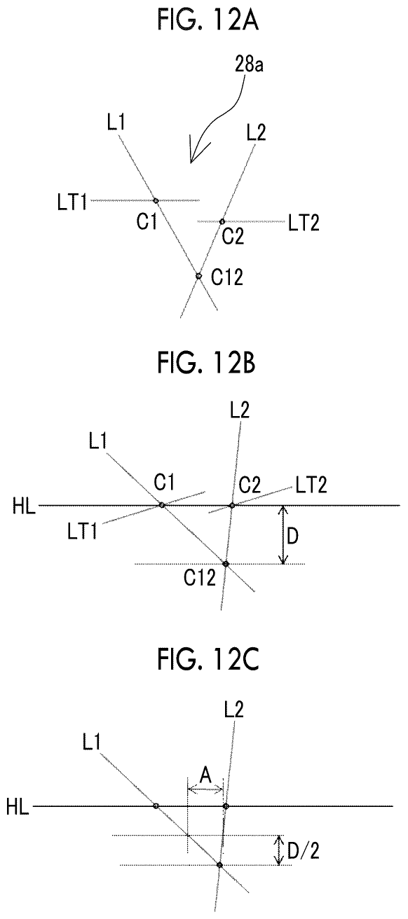

In FIG. 11A, the white portion is a portion closer to the surface, and the black portion is a portion closer to the substrate. In FIG. 11, a shape in which fine unevenness is densely formed is observed. The black portion corresponds to the hole portion 28a. The depth of the hole portion 28a is determined by the following procedure. First, in the cross section shown in FIG. 11B, straight lines L1 and L2 are drawn on a left inclined surface and a right inclined surface of the hole portion 28a, and horizontal straight lines LT1 and LT2 are drawn on each inclined surface top portion. FIG. 12A shows the straight lines L1, L2, LT1, and LT2 drawn in FIG. 11B. An intersection of the straight line L1 drawn on the left inclined surface and the horizontal straight line LT1 drawn on the left inclined surface top portion is denoted by C1, and an intersection of the straight line L2 drawn on the right inclined surface and the horizontal straight line LT2 drawn on the right inclined surface top portion is denoted by C2. In addition, an intersection of the straight line L1 and the straight line L2 is denoted by C12. The intersection C12 is a bottom of the hole portion 28a. Then, as shown in FIG. 12B, tilt correction is performed to rotate the straight lines L1, L2, LT1, and LT2 such that the intersections C1 and C2 match a horizontal straight line HL. A distance between the hole portion 28a after the tilt correction and the intersection C12 of the straight line HL is denoted by a depth D. In addition, as shown in FIG. 12C, an opening diameter of the hole portion 28a at a position of half of the depth D, that is, D/2 is denoted by an opening diameter A. In Table 1, an average value of the measured values (depth D) at a plurality of locations (any three locations in a range of 1 μm×2 μm in the acquired AFM image) is shown.

As shown in Table 1, the depth of the hole portion rapidly increased as the annealing temperature exceeded 300° C. It is noted that the depth of the hole portion includes an error of about 1 nm, and Examples 1 to 3 are considered to be of the same degree within the error range.

It is noted that, although not shown in the table, the opening diameter of the hole portion also does not change significantly from 100° C. to 300° C. in the same manner as the depth of the hole portion, but rapidly increases as the annealing temperature exceeds 300° C.

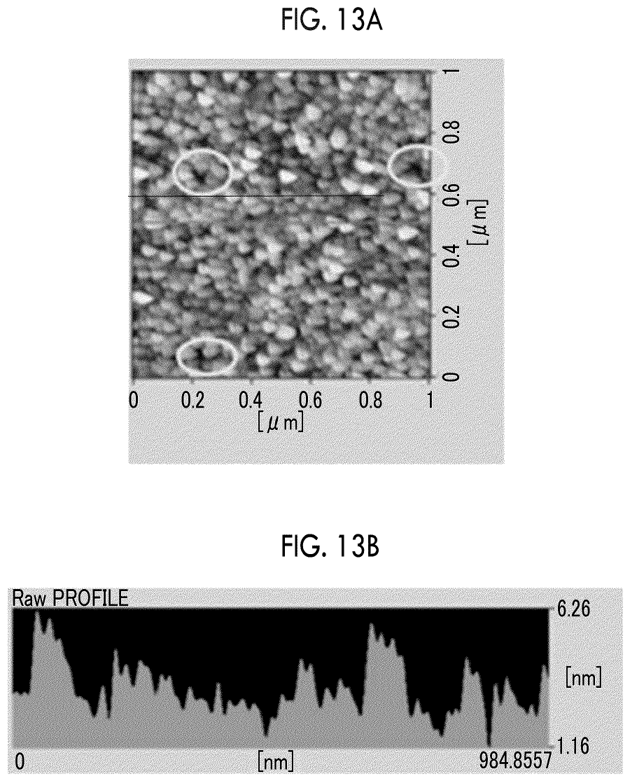

FIG. 13A is an AFM image of the surface of the adhesion control layer of the electroforming master plate of Example 1, and FIG. 13B is a cross-sectional image of a straight line shown in the AFM image. As in FIGS. 11A and 11B, the units of the vertical axis and the horizontal axis of FIG. 13A are [μm], and the units of the vertical axis and the horizontal axis of FIG. 13B are [nm].

The adhesion control layer of Example 1 of the 200° C. annealing shown in FIGS. 13A and 13B has a surface shape in which a plurality of protrusions having a tapered shape are densely formed. As described above, the actual adhesion control layer has fine unevenness having a height difference of about 5 nm or less, in which the height of the surface and the depth of the recessed portion are random. On average, as shown in Table 1, the average value of the depth of the hole portion (unevenness height difference) is 1.9 nm.

On the other hand, the adhesion control layer of Example 5 of the 400° C. annealing shown in FIGS. 11A and 11B has an opening width of 100 nm to 200 nm, and has relatively large unevenness having a large recessed portion having a depth of about 20 nm and relatively small unevenness having a depth of 10 nm or less provided on a protrusion of the unevenness. As shown in Table 1, the average value of the depth of the recessed portion (unevenness height difference) is 7.8 nm. This is a numerical value in which the depths of the large unevenness and the small unevenness are averaged.

### Measurement of Thickness of Adhesion Control Layer

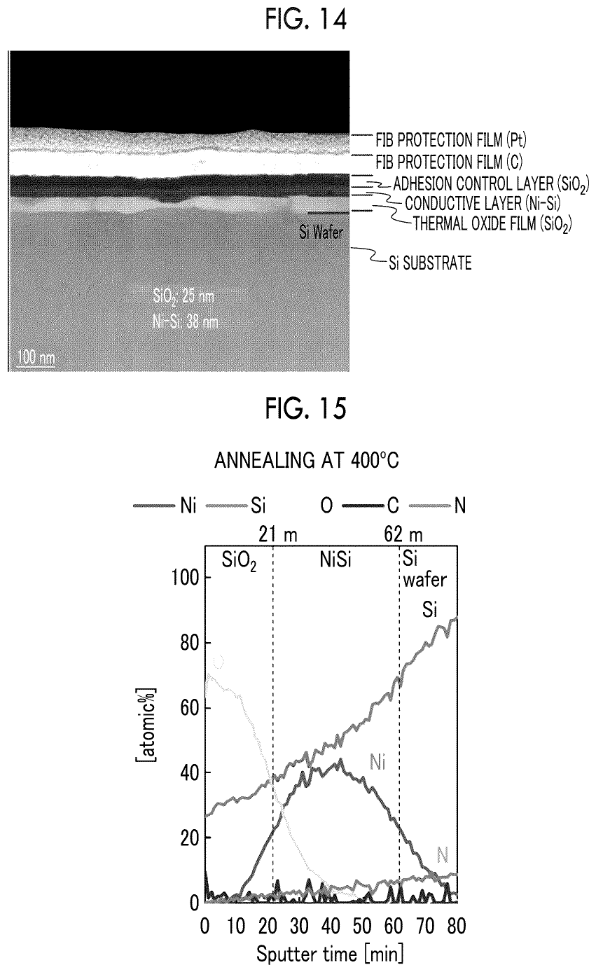

The thickness of the adhesion control layer was obtained as follows. For the electroforming master plate of Example 5, a TEM image shown in FIG. 14 was acquired. Then, the thickness of the SiO₂ layer, which is the adhesion control layer of the electroforming master plate of Example 5, was obtained from the TEM image shown in FIG. 14. As shown in FIG. 14, the thickness of the SiO₂ layer of Example 5 was 25 nm. In addition, for the electroforming master plate of Example 5, the composition analysis was performed using X-ray photoelectron spectroscopy (XPS) while digging in the depth direction from the surface of the electroforming master plate by sputtering, and a graph showing a relationship between the content of the element shown in FIG. 15 and the digging time (sputter time) in the depth direction was acquired. In the graph shown in FIG. 15, the depth from the surface to a depth at which the ratio of silicon (Si) to oxygen (O) is 1:1 was defined as the adhesion control layer. In the case of FIG. 15, at the time of digging for 21 min, the ratio of silicon to oxygen was 1:1. In comparison with the thickness of 25 nm of the adhesion control layer measured from the TEM image shown in FIG. 14, it can be seen that the thickness of the adhesion control layer is 25 nm up to the position dug for 21 minutes.

For Examples 1 to 4 other than Example 5, the same compositional analysis as in FIG. 15 by XPS was performed, and the thickness of the adhesion control layer was estimated based on the relationship between the thickness of the adhesion control layer and the digging time for Example 5. Specifically, the time from the surface of the electroforming master plate until the ratio of silicon to oxygen is 1:1 was converted into the thickness.

As shown in Table 1, the thickness of the adhesion control layer was also substantially the same at an annealing temperature of 200° C. to 300° C. In addition, it was found that, as the annealing temperature exceeded 300° C., the thickness of the adhesion control layer tended to increase with an increase in the temperature.

It is noted that, in Examples and Comparative Examples, the annealing temperature was not set lower than 200° C. because the diffusion of silicon and nickel was not sufficient at an annealing temperature of 190° C. or lower.

### Measurement of Contact Area

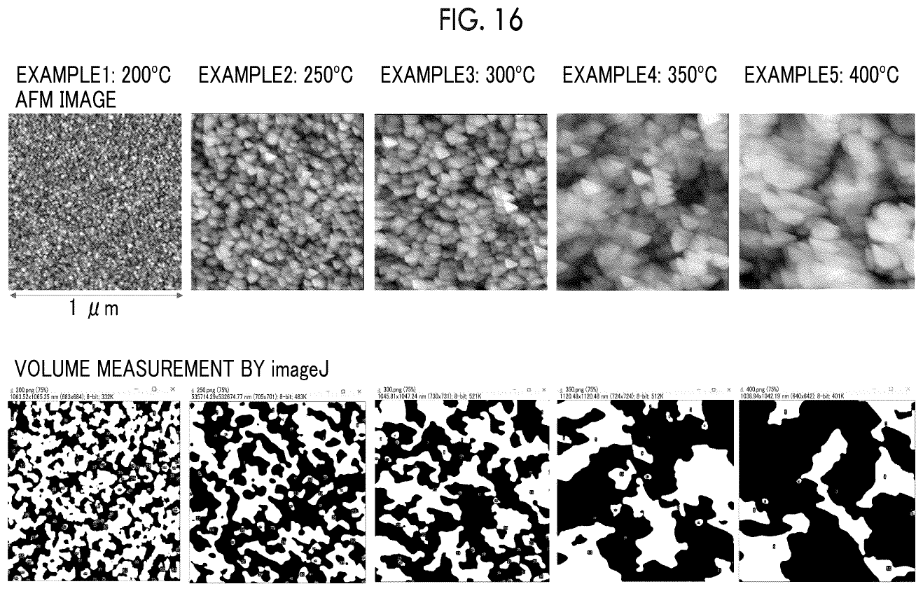

The AFM image of the surface of the adhesion control layer was acquired and calculated using general analysis software (imageJ). FIG. 16 is an AFM image of the surface of the adhesion control layer of the electroforming master plates of Examples 1 to 5. The AFM image is an image of 1 μm×1 μm. The images shown below each AFM image are images used for volume measurement by the analysis software imageJ. The median filter processing was set to “10” pixels, and the brightness of 0 to 100 was set to white, and the brightness of 101 or more was set to black. In the image for volume measurement, a white portion was defined as the contact area, and a ratio of the white portion to the image area was calculated as the contact area [%]. From the results shown in Table 1, it is considered that the contact area is preferably 20% to 60%.

### Evaluation of Electroformed Product

The state in a case of peeling the electroformed product from the master plate was evaluated according to the following criteria.
A: The electroformed product can be peeled off without destroying the master plate.
B: The adhesiveness between the master plate and the electroformed product is high, but the electroformed product can be peeled off.
C: The electroformed product is peeled off during the electroforming, or the adhesiveness between the master plate and the electroformed product is so strong that the electroformed product cannot be peeled off.

As shown in the row of the adhesion force between the master plate and the electroformed product in Table 1, the lower the annealing temperature, the greater the adhesion force, and the higher the annealing temperature, the lower the adhesion force. In Comparative Example 1, the adhesion force was too large, and the master plate could not be peeled off from the electroforming master plate. In addition, in Comparative Example 2, the electroforming metal could not be deposited by the electroforming. From the results shown in Table 1, it is considered that the annealing temperature is preferably higher than 300° C. and lower than 500° C.

### Roughness of Electroformed Product on Master Plate Side

The surface roughness of the surface of the electroformed product on the electroforming master plate side was measured.

The surface roughness was measured by AFM. Table 1 shows the average values at three locations in a range of 1 μm×1 μm.

As described above, in Examples 1 to 5 in which the thickness of the adhesion control layer satisfied 1 nm or more and 50 nm or less, the electroforming was possible even though the adhesion control layer was provided on the surface of the conductive layer. That is, the surface conductivity of the electroforming master plate is ensured. In addition, in Examples 1 to 5, the adhesiveness of the electroformed product to the master plate could be reduced, and the electroformed product could be favorably peeled off.

### Surface Evaluation of Electroformed Product

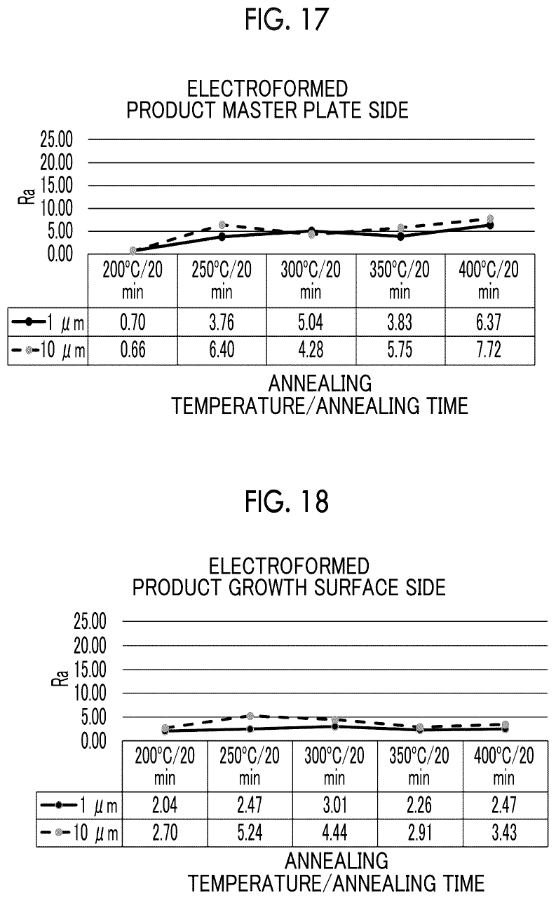

FIG. 17 and FIG. 18 show the results of measuring the surface roughness of the electroformed product deposited with a thickness of 1 μm and the electroformed product deposited with a thickness of 10 μm using the electroforming master plates of Examples 1 to 5. The method of measuring the surface roughness is the same as described above. FIG. 17 and FIG. 18 are graphs in which the numerical values in the tables shown below the graphs are graphed. The vertical axis is the surface roughness Ra, and the unit is [nm].

FIG. 17 is the surface roughness of the surface of the electroformed product on the electroforming master plate side, and FIG. 18 is the surface roughness of the surface of the electroformed product on the growth surface side. As shown in FIG. 18, the surface roughness on the growth surface side did not change depending on the annealing temperature. On the other hand, as shown in FIG. 17, the surface roughness of the surface on the electroforming substrate side tended to increase as the annealing temperature increased. It is considered that this is due to the difference in the surface shape of the adhesion control layer on the surface of the electroforming master plate.

In regard to the embodiment described above, the following supplementary notes will be further disclosed.

### Supplementary Note 1

An electroforming master plate comprising:
a substrate;
a conductive layer provided on a surface of the substrate;
an insulating mask pattern provided on the substrate or the conductive layer; and
an adhesion control layer provided on the conductive layer, in which the adhesion control layer is a porous film formed of an insulating material and has a thickness of 1 nm to 50 nm, the thickness being thinner than a thickness of the insulating mask pattern.

### Supplementary Note 2

The electroforming master plate according to Supplementary Note 1, in which a residual film thickness in a hole portion of the adhesion control layer is 15 nm or less.

### Supplementary Note 3

The electroforming master plate according to Supplementary Note 1 or 2, in which the adhesion control layer does not include a metal forming an electroformed product.

### Supplementary Note 4

The electroforming master plate according to any one of Supplementary Notes 1 to 3, in which a contact area between the conductive layer and an electroforming solution is 20% to 60% of a total area of the conductive layer beneath the adhesion control layer.

### Supplementary Note 5

The electroforming master plate according to any one of Supplementary Notes 1 to 4, in which the insulating mask pattern includes a dot or a line having a height of 50 nm or more and a width of 50 nm or more.

### Supplementary Note 6

The electroforming master plate according to any one of Supplementary Notes 1 to 5, in which the substrate is silicon, and the conductive layer is an alloy of silicon and a metal.

### Supplementary Note 7

The electroforming master plate according to Supplementary Note 6, in which the adhesion control layer is a silicon oxide.

### Supplementary Note 8

A manufacturing method for an electroforming master plate, comprising:
a step of removing a natural oxide film on a silicon substrate having an insulating mask pattern on a surface of the silicon substrate;
a step of forming a metal film on the silicon substrate;
a step of forming a capping layer on the metal film;
a step of annealing a structure including the metal film and the capping layer on the silicon substrate; and
a washing step of removing the capping layer.

### Supplementary Note 9

The manufacturing method for an electroforming master plate according to Supplementary Note 8, in which, in the step of removing the natural oxide film, the natural oxide film is removed by reverse sputtering using argon under vacuum.

### Supplementary Note 10

The manufacturing method for an electroforming master plate according to Supplementary Note 8 or 9, in which after the step of removing the natural oxide film, the step of forming a metal film and the step of forming the capping layer are performed without returning to an atmospheric environment.

### Supplementary Note 11

The manufacturing method for an electroforming master plate according to any one of Supplementary Notes 8 to 10, in which the annealing is performed at a temperature of 200° C. to 400° C.

### Supplementary Note 12

The manufacturing method for an electroforming master plate according to any one of Supplementary Notes 8 to 11, in which, in the washing step, the capping layer is removed using an acid washing solution.

### Supplementary Note 13

An electroformed product manufactured using the electroforming master plate according to any one of Supplementary Notes 1 to 7, in which the electroformed product has, on one surface, a structural portion corresponding to the insulating mask pattern and unevenness having a depth of 1 nm to 50 nm and a surface roughness of 1 nm to 10 nm, the unevenness corresponding to unevenness of the surface of the porous film.

What is claimed is:

1. An electroforming master plate comprising:
a substrate;
a conductive layer provided on a surface of the substrate;
an insulating mask pattern provided on the substrate or the conductive layer; and
an adhesion control layer provided on the conductive layer,
wherein the adhesion control layer is a porous film formed of an insulating material and has a thickness of 1 nm to 50 nm, the thickness being thinner than a thickness of the insulating mask pattern.

2. The electroforming master plate according to claim 1,
wherein a residual film thickness in a hole portion of the adhesion control layer is 15 nm or less.

3. The electroforming master plate according to claim 1,
wherein the adhesion control layer does not include a metal forming an electroformed product.

4. The electroforming master plate according to claim 1,
wherein a contact area between the conductive layer and an electroforming solution is 20% to 60% of a total area of the conductive layer beneath the adhesion control layer.

5. The electroforming master plate according to claim 1,
wherein the insulating mask pattern includes a dot or a line having a height of 50 nm or more and a width of 50 nm or more.

6. The electroforming master plate according to claim 1,
wherein the substrate is silicon, and the conductive layer is an alloy of silicon and a metal.

7. The electroforming master plate according to claim 6,
wherein the adhesion control layer is a silicon oxide.

8. A manufacturing method for an electroforming master plate, comprising:
a step of removing a natural oxide film on a silicon substrate having an insulating mask pattern on a surface of the silicon substrate;
a step of forming a metal film on the silicon substrate;
a step of forming a capping layer on the metal film;
a step of annealing a structure including the metal film and the capping layer on the silicon substrate; and
a washing step of removing the capping layer.

9. The manufacturing method for an electroforming master plate according to claim 8,
wherein, in the step of removing the natural oxide film, the natural oxide film is removed by reverse sputtering using argon under vacuum.

10. The manufacturing method for an electroforming master plate according to claim 8,
wherein after the step of removing the natural oxide film, the step of forming a metal film and the step of forming a capping layer are performed without returning to an atmospheric environment.

11. The manufacturing method for an electroforming master plate according to claim 8,
wherein the annealing is performed at a temperature of 200° C. to 400° C.

12. The manufacturing method for an electroforming master plate according to claim 8,
wherein, in the washing step, the capping layer is removed using an acid washing solution.

13. An electroformed product manufactured using the electroforming master plate according to claim 1,
wherein the electroformed product has, on one surface, a structural portion corresponding to the insulating mask pattern and unevenness having a depth of 1 nm to 50 nm and a surface roughness of 1 nm to 10 nm, the unevenness corresponding to unevenness of the surface of the porous film.
